(19) United States
(12) Patent Application Publication
(10) Pub. No.: US 2016/0125967 A1
(43) Pub. Date: May 5, 2016

(54) COMPOSITION ENABLING CONTROL OVER NEUTRALIZING RADIOACTIVITY USING MUON SURROGATE CATALYZED TRANSMUTATIONS AND QUANTUM CONFINEMENT ENERGY CONVERSION

(71) Applicant: Tionesta Applied Research Corporation, Sequim, WA (US)

(72) Inventors: Anthony ZUPPERO, San Diego, CA (US); Thomas J. DOLAN, Urbana, IL (US); William David JANSEN, San Diego, CA (US); William SAAS, Westlake, OH (US); Craig V. BISHOP, Grafton, OH (US); Paul CRONE, Sequim, WA (US)

(21) Appl. No.: 14/933,487

(22) Filed: Nov. 5, 2015

Related U.S. Application Data
(60) Provisional application No. 62/075,587, filed on Nov. 5, 2014.
(60) Provisional application No. 62/237,235, filed on Oct. 5, 2015.

(51) Int. Cl. G21G 1/00

(52) U.S. Cl. CPC G21G 1/0005

(57) ABSTRACT

A binding reaction creates transient, elevated effective mass electron quasiparticles as surrogates for a heavier muon, to cause muon-catalyzed fusion transmutations with the surrogates and creates a composition of matter that enables neutralizing certain radioactive waste nuclei. Tailoring a junction of a device enhances the control of the surrogate's transient effective mass.

### CROSS REFERENCE TO RELATED APPLICATIONS

This application claims the benefit of U.S. Provisional Application No. 62/075,587, filed Nov. 5, 2014. This application also claims the benefit of U.S. Provisional Application No. 62/237,235, filed Oct. 5, 2015. The contents of the above two identified applications are incorporated herein by reference in their entirety.

### FIELD OF THE INVENTION

This invention relates generally to systems, methods and a composition of matter to control muon catalyzed fusion, and more particularly to methods to create muon surrogate electrons to enhance the binding reactions of the transmutations to neutralize certain radioactive waste nuclei.

### BACKGROUND

Muon catalyzed fusion, a transmutation reaction, has been well known for more than half a century. A muon replaces an electron in a deuterium molecule. Because the dimension of an atom is inversely proportional to the mass of the negative particle, the heavy mass of muon, about 207 times that of a vacuum electron, means that the dimension of a muonic D₂ molecule becomes small enough for nuclear strong force potentials to overlap, inducing fusion. A small dimension permits tunneling through the coulomb barrier. However, referring to FIG. 4A, the negative particle is not trapped between the two positives. Therefore when the two nuclei are drawn together by their mutual binding potential, the energy can't be transferred to the negative particle. The issue is that the negative particle is not trapped between reactants.

A tri-body reaction type discovered in chemical physics uses a negative particle trapped between reactants. This leads to a D₂⁺ ion model where one potential traps an electron between nuclei and the binding potential between nuclei binds the nuclei together independent of the negative particle. In this reaction type, there is no coulomb barrier against fusion or binding. A coulomb attraction exists instead. Fusion is prevented because nuclei are held apart by the quantum confinement energy (QCE) of the low mass electron.

When a muon is used instead of an electron as in FIG. 4B its high, approximately 207 electron mass, reduces QCE so much that only some of the energy goes into QCE. The rest of the energy goes into energetic or radioactive emissions, and not into binding of reactants. When mass of the negative particle is intermediate, between that of an electron and a muon, the QCE can be greater than binding energy at the inner turning point of the molecular vibration. At the same time the QCE can be low enough to bring the nuclei within range of their mutual binding potential. Calculations and some observations show this condition results in a strong preference for a slow but non-zero reaction rate, and more useful, the product of the reaction is a bound combination of the isotopes of hydrogen and the reactant nucleus, and the product is born in the ground state, cold and non-radioactive.

There is therefore a need for an intermediate mass electron such as an electron quasi particle to become a surrogate for the muon, as in FIG. 4C.

The electron effective mass can be raised transiently, during the short time during which the electron is ballistic. This duration is about ˜10 femtoseconds. The effective mass has a value proportional to the inverse of the curvature of the energy versus crystal momentum of the electron (E vs k) in the material. A high effective mass occurs when the curvature of the band structure diagram vanishes, which is at an inflection point. To achieve this requires adding both energy (dE) and crystal momentum (dk) to be at or near an inflection point. It is difficult to target dk for “large values,” those far from the gamma point (the origin). It is especially difficult to target values towards high end of the first Brillouin Zone (BZ). At the high end of the BZ, the wavelength of a lattice impulse is smallest, of order the dimension of unit cell of a crystal of the material. Large relative value of dk can be injected when a reactant hydrogen isotope crosses over a barrier from one proton conductor to another. This happens when the protons or hydrogen isotope nuclei cross an abrupt junction. When barrier is thinnest, e.g. 1 atom, then the dk is large. There is therefore a need for abrupt junctions.

All the transmutation reactions are apparently inefficient. Experiments show that hydrogen must flow for days to react a mere 1e14 nuclei. Therefore there exists a need for a way to circulate hydrogen, preferably with no moving parts and electrically controlled.

The tri-body associated with conventional muon fusion does not conform to the D₂⁺ ion model. Furthermore, a system to control transmutation reactions requires both a measurable amount of transmutations and reactants. It would therefore be useful to have a composition of matter including a useful number of tri particles conforming to the D₂⁺ ion model and having a measurable amount of transmutations.

Radioactive fission products are born from neutron rich elements. Therefore it would be highly useful to have a composition of matter that promotes proton binding reactions with the fission products used as reactants to neutralize radioactivity.

### BRIEF DESCRIPTION OF THE DRAWINGS

FIG. 1 shows a symbolic composition of matter surrounded by various devices to use and/or create the composition.

FIG. 2 shows a cross section of a thin film with reactants both on and in a proton and electron conductor.

FIG. 3 shows a cross section of thin films stacked between proton conductors.

FIG. 4A shows a muon catalyzed fusion configuration.

FIG. 4B shows a muon catalyzed attraction reaction configuration.

FIG. 4C shows a muon surrogate in a muon surrogate catalyzed attraction reaction configuration.

### DETAILED DESCRIPTION

Described herein is a composition of matter associated with controlling the quantum confinement energy conversion in the binding branch of muon surrogate catalyzed transmutations. Also described are methods and apparatus to circulate reactants through a reaction region, and a way to enhance the targeting of stimulation parameters used to control the reaction.

Only the mass and single negative charge of the muon, or its surrogate, are the useful properties that catalyze the reactions. Raising effective mass to a controlled value requires adding targeted value of dk and dE to a conduction electron. The more difficult addition is crystal momentum (dk). Crystal momentum is injected when a hydrogen isotope crosses from one region in a proton conductor to another. The sharpness of boundary determines the value of dk. A short dimension is associated with a large crystal momentum transfer.

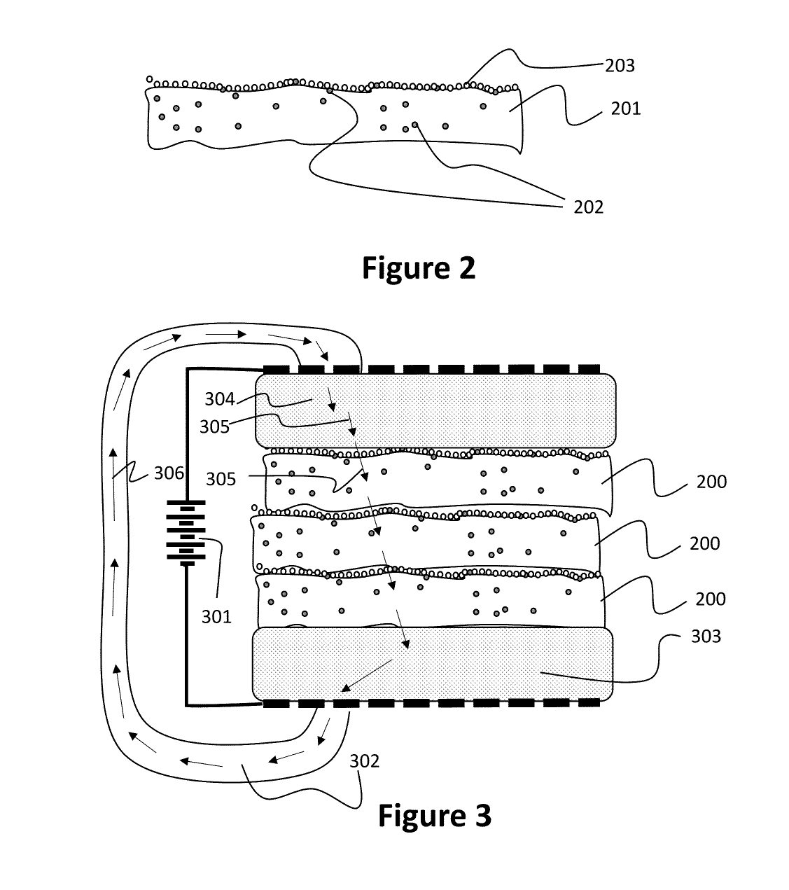

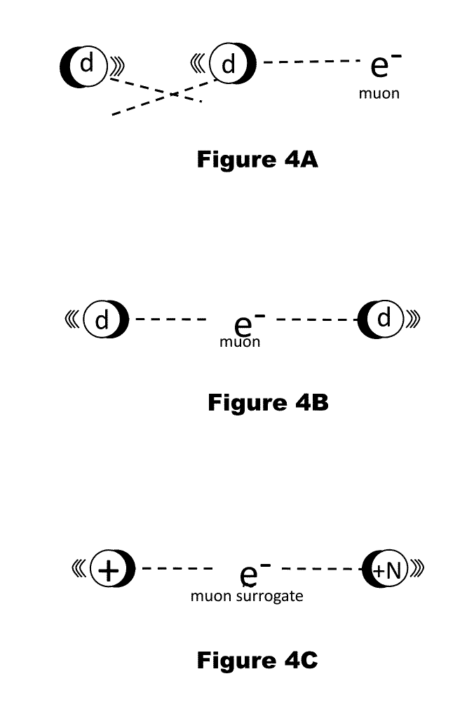

One way to do this is to use thin films as reaction regions, as in System 200 of FIG. 2, and then physically stack the films against each other as in System 300 of FIG. 3. This provides a “one atom” junction 203. Reactant 202 is embedded in or on the thin film 201. It has been calculated and observed that reactions rapidly dwindle past about 10 nm from a junction. Reaction regions 304 and hence thin films 201 as thin as 40 nm have worked. An abrupt junction 203 can consist of a layer of one atom, or the junction of one type proton conductor with another. For example, a palladium thin film coated with one or a several atom layers of reactant or other material permeable or semi-permeable to hydrogen can form an abrupt junction. One film of one type of proton and electron conductor, such as palladium, placed in physical contact with another type, such as titanium, vanadium, or other proton and electron conductors can form an abrupt junction. Another type can be a proton electron conductor such as palladium with a proton electrolyte, such as Nafion 304. Such thin films can be stacked, as in System 300. The limiting number of stacks is determined practically when the flow of hydrogen isotope dwindles. The flow is inversely proportional to the number of thin film layers. A typical thin film 201 would be a 2 to 20 nanometer thin film of palladium coated or permeated with reactants such as radioactive materials.

In all the configurations, hydrogen isotope nuclei 306 must be passed through reaction region 200. Hydrogen isotopes 306 include hydrogen, deuterium and tritium, and become protons, deuterons and tritons 305 in proton conductors 304 and proton and electron conductors 201. Most of the hydrogen is not reacted. The hydrogen 306 typically enters from a high pressure region on one face of a thin film stack and exits on another face to a vacuum. Circulation of the hydrogen isotope conserves isotope. Circulation can be achieved by injecting the hydrogen isotope using an input side proton electrolyte 304, passing the hydrogen isotope 305 through the thin film stack, and collecting the hydrogen isotope into an output side proton electrolyte 303. Applying a voltage 301 across the entire sandwich of proton electrolyte 304, thin film stack 200 and proton electrolyte 303 causes the protons to flow through the stack. This also pumps the output side hydrogen back to input side. Such electric circulation requires no moving parts.

A known hydrogen isotope pump applies a voltage 301 across the entire stack 304, 200, 303.

A proton electrolyte 303, 304 such as Nafion and a proton and electron conductor such as palladium 201, can each be used as conduits or pipes to convey hydrogen isotopes to reaction regions.

### Forming a Composition of Matter

The transmutation reaction resulting from the binding reaction branch requires that each unit reaction entity uses three particles comprising: 1. a delocalized, singly positively charged reactant; 2. a possibly delocalized, positively charged reactant; and 3. a delocalized, single negative charge carrier between them. The unit reaction entity comprising the three particles is referred to as a “tri-particle.” One or more tri particles can share a common reactant. The delocalized particles must move and act like particles of an H₂⁺ ion, a gas molecule, and conform to the H₂⁺ ion configuration.

In the following p=proton, d=deuteron, t=triton, e−=negative charge carrier particle, +N is reactant with N positive charges, and T is the transmuted product.

The acceptable forms of the tri particle therefore include, T compositions of matter comprising, symbolically, [p e− +N]→T, [d e− +N]→T, and [t e− +N]→. This allows any isotope of hydrogen as a candidate for the singly positively charged reactant. The p (proton), d (deuteron) and t (triton) must be sufficiently free to move under the attractive coulomb force of the negative charge e− between them and the reactant with coulomb charge +N.

The reactants are chosen such that the masses of the forms of hydrogen plus reactant are greater than that of the transmutations formed from these reactants. The difference in mass is referred to as a positive mass defect when reactants weigh more than transmutations.

Acceptable forms of tri particle may use a common +N reactant. In this composition, multiple hydrogen isotopes can bind to the +N, resulting in transmutations. The composition must therefore include a density of both delocalized hydrogen isotopes and delocalized muon surrogates equal to at least one per reactant, and at least as many hydrogen isotopes and as are required by the condition of positive mass defect.

When stimulating quantum confinement energy conversion reactions it is highly useful to have sufficient reactant and transmutations to measure the reaction progress and provide reactant and transmutations composition signals to the control system. It is therefore highly useful to have a composition of matter including tri particles as reactants and a useful amount of reactant and transmutations for control system signals.

It is known that muon surrogates can be created from lattice conduction electrons by adding both electron energy and crystal momentum. To create a muon surrogate, transiently elevate the electron effective mass in a crystal by adding crystal momentum dk and electron energy dE simultaneously in a reaction region, with values of crystal momentum and electron energy that target an inflection point of the band structure. Values up to about ¼ of muon mass can be expected. Multiple ways are known in the literature to add crystal momentum and electron energy.

The resulting muon surrogate is an elevated effective mass electron quasi particle with a transient effective lifetime. A normal electron quasi particle lifetime, approximately the electron-electron collision time, is of order 10 femtoseconds. More precisely, the elevated effective mass lasts until the electron collides with something that changes its energy. The density of surrogates can therefore rise to some useful fraction of the conduction electron density in the crystal.

The electron must be delocalized in the region between the positive reactants.

### Energize an Electron

Creating the muon surrogate is the difficult and novel element enabling control over the reaction. To create a muon surrogate, an electron was transiently energized in an electron and proton conductor in a way where it acquires both an energy and a crystal momentum near an inflection point of its governing energy versus momentum diagram. The effective mass of an electron is inversely proportional to the curvature of the energy/crystal momentum locus of points. At an inflection point, the curvature vanishes and the effective mass rises to maximum. This effective mass is a transient lasting about as long as the time between electron collisions, or about 10 femtoseconds.

Calculations suggest the effective mass for an electron quasi particle will achieve about as many times the mass of an electron as the number of atoms it travels before an electron-electron collision. This distance ranges from about 5 to about 60 atoms, or up to about 20 nanometers. The achievable effective mass of the muon surrogate is therefore between about 5 and about 60 electron masses and lasts for about 10 femtoseconds.

To achieve muon transmutation efficiently, the muon must never attach to one or the other positive reactants. This is achieved when the muon or its surrogate has enough potential energy to reside between the reactants. Energizing hydrogen isotopes and electrons to be delocalized in a proton and electron conductor achieves this.

This attractive reaction branch concentrates all the kinetic, trapping and binding energy into the quantum confinement energy, once during each oscillation and at the inner turning point of the oscillation.

To achieve a mobile positive charge in the same region as muon surrogates, a proton conducting electron conductor was used, such as palladium, nickel, titanium, zirconium, vanadium, and a host of other materials too numerous to mention.

A muon surrogate is transiently energized in the vicinity of a reactant ion and a delocalized isotope of hydrogen such as one or more protons, deuterons or tritons. A template configuration was used which includes a muon electrostatically trapped between a singly charged positive mass and a multiply charged mass. This configuration is like that of a D₂⁺ muonic ion, where both the positive charges and the muon are mobile and free of other potentials.

An energy was provided to delocalize, ionize or otherwise convert the positive charged isotope of hydrogen into a mobile particle in the proton conductor. Such a condition renders the isotope a quasi particle.

One way to add crystal momentum is to flow the hydrogen isotope across an abrupt junction. An example of such a junction would use as a basic building block a thin film of palladium with thickness 5 to 20 nanometer and impregnated with the desired reactant. When multiple sheets of impregnated thin films are physically placed on top of each other, together, an abrupt junction is formed. By including a reactant or proton conducting material at this junction one can guarantee an abrupt junction. The smallest dimension junction provides the highest crystal momentum transfer.

Control over the value of the crystal momentum can therefore be achieved by adjusting the number of atoms of “other” material between the thin film reaction regions.

Reactant hydrogen can be delivered and conveyed directly to the reaction region by use of proton electrolytes such as Nafion.

One way to monitor the injection of crystal momentum into the reaction region includes using radioactive tracers and reactants. The radioactive material needs to be chosen from those where the mass defect for the reaction is positive. For example, using Cs¹³⁷ one would expect that 4 protons would result 4 tri-particle unit reactions with the Cs to produce stable Pr.

Calculations suggest that the concentration of radioactive reactants used as reaction tracers can be achieved using less than 1 nano-curies of radioactive material per square centimeter of reaction thin film.

When such a reaction region is created or provided, the reaction branch allows the quantum confinement energy conversion (QCEC) branch to be active. QCEC results in a partition of the binding energy of the reactants into electron quasi particles and a vibrationally excited transmutation. This reaction is referred to as a binding reaction.

When the mass of the muon surrogate is between about 5 and about 50 vacuum electron masses, the binding reaction occurs only during a coincidence of non-vanishing wave function in the tails of the wave functions of the muon surrogates and of the reactants. The transmutation is expected to be in the ground state. The ground state of the transmutation has no turning points, and therefore can provide the most probable wave function overlap of muon surrogate, forms of hydrogen and reactant.

Note that surrogates with effective mass between 5 and 50 convert the entire mass defect energy into quantum confinement energy, even when the reactant is radioactive. The transmutation product is non-radioactive. The ground state of the transmutation product is apparently the most probable result, because it offers the largest overlap of wave functions at the inner turning point, where all the reactant, tri particle and transmutation wave functions are stationary. Such a composition of matter therefore can be used to neutralize radioactivity with reactants having positive mass defect.

Examples of binding reactions using the composition of matter described here include both stable and radioactive elements. For example, natural, stable caesium 133 and 4 deuterons would form praseodymium 141 with a quantum confinement energy excess of about 50.5 MeV in electron quasi particles. Similarly, radioactive fission product caesium 137, and 4 protons would also form stable praseodymium 141 with about 28.6 MeV QCE in electron quasi particles. Similarly, stable strontium 88 and 4 deuterons form molybdenum 96 with about 53 MeV QCE, and radioactive strontium 90 with 4 protons forms molybdenum 94 with about 31.6 MeV QCE. As a general rule, neutron rich fission products are remediated using protons. The periodic table is replete with such examples, far too numerous to list.

Further examples include radioactive cesium 137 binds with a proton to form non-radioactive barium 138 and 9 MeV QCE, with two protons to form lanthanum 139 and 15.3 MeV QCE. Similarly radioactive strontium 90 may bind with two protons to form stable zirconium 92 and 17.1 MeV QCE.

A muon surrogate catalyzed transmutation can be sustained when an industrially useful number of singly negatively charged entities having an elevated effective mass relative to that of a vacuum electron are co-located in a region of delocalized isotopes of hydrogen and suitable reactants. The entities must reside in the region where the positively charged transmutation reactants can freely merge, bind or fuse with the singly charged reactants such as a proton, deuteron or triton.

Therefore one must use a material for the reaction region where the hydrogen or proton is also a delocalized quasi particle in the same material containing the elevated effective mass electron quasi particle and the reactant that will undergo a merging, binding or fusion reaction with protons.

Such materials are well known to those who perform fusion research and are used in the so-called first wall. These include, for example, titanium, vanadium, niobium, palladium, tantalum, nickel, iron, and also includes those materials used to store hydrogen for use in energy applications.

A composition of matter enabling the desired transformation includes delocalized muon surrogates, suitable reactants including delocalized hydrogen and an isotope to be transmuted, and also contains some of the reaction transmutations.

A control system needs to dynamically measure the concentration of transmutations and reactant and any other emissions related to the reaction. A system permitting industrial feedback sensors to monitor the reaction would operate best when the transmutations concentration exceeds about 1% of the reaction transmutations.

A composition of matter including between 1% and 90% reactant and 1% and 90% transmutations are sufficient for providing controlling reaction signals. These concentrations apply to a region within about 20 nanometers of the reaction region interface with its surroundings.

The surroundings may be any form, solid, liquid or gas.

A distinct advantage of using elevated effective mass electron quasi particles as muon surrogates is the extremely high density of such quasi particles in the reaction region of the elements to be transmuted, compared to current muon particle densities.

One may also use this composition of matter in a system neutralizing radioactivity of fission product materials. Fission product isotopes are typically neutron rich. Therefore using proton reactants in the composition of matter tend to result in transmutations with stable neutron ratios.

Muons can be used instead of muon surrogates in the binding reaction. When muons are used, the forms of hydrogen isotope must be bare nuclei and not be attached to any muon. An ionized gas of deuterium is an example. These forms need not be quasi particles. However, the muon mass is so high that energy is not completely absorbed by the muon at the inner turning point. This results in reactions with radioactive or highly energetic products.

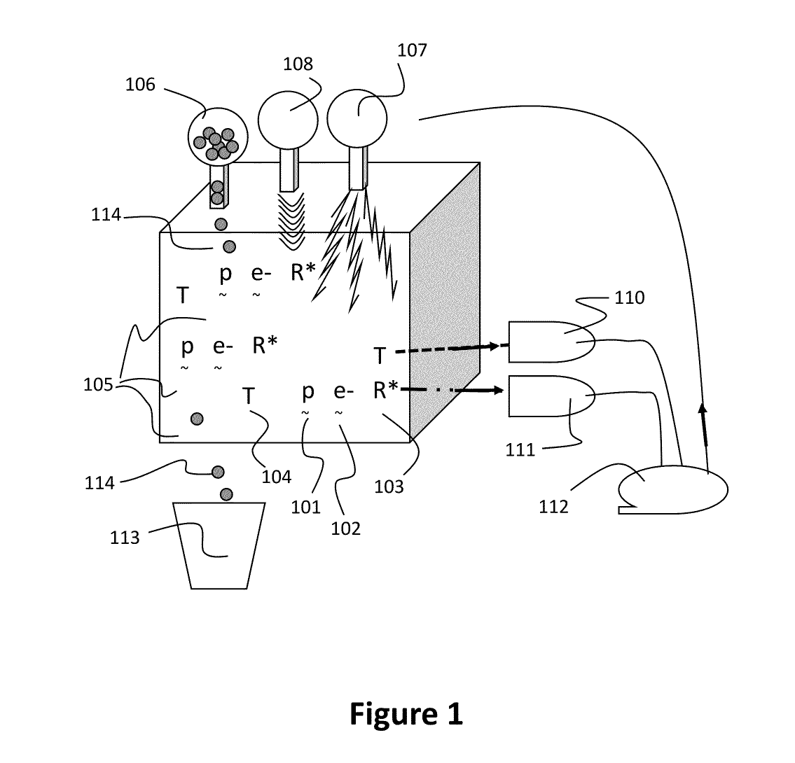

In FIG. 1 including system 100, p with a tilde under it 101 represents a singly charged positive bare ion that is delocalized. The term e− with a tilde under it 102 represents a muon surrogate, also delocalized. The term R* 103 represents a radioactive fission product reactant that may or may not be delocalized. The term T 104 represents a stable table transmutations. A reaction region 105 includes materials where both the positives p, d or t and negative muon surrogates can be delocalized and present simultaneously. The reaction region 105 may be of limited dimension in some embodiments, of order 20 nm or less. The system includes at least a hydrogen isotope mass 114 injection means 106, an energy injection means 107, a crystal momentum injection means 108, a reactant sensing means 110, a transmutations sensing means 111, a control system 112, and an unreacted hydrogen sink means 113.

It is recognized that certain materials cause material and reaction compatibility problems. Therefore the contraction of incompatible materials in the reaction region is less than 1%. Incompatible materials include nickel combined with forms of lithium.

What is claimed is:

1. A composition of matter enabling quantum confinement energy conversion branch of a muon surrogate catalyzed transmutation reaction in a reaction region and enabling its feedback control system, the composition including:
a reactant region and one or more reactants in the region;
one or more delocalized hydrogen ion isotopes in the region;
one or more muon surrogates in the region;
a transmutation product of the binding of one or more hydrogen isotopes with a reactant;
where the reactant and hydrogen isotopes are chosen to have a positive mass defect with respect to the transmutation product; and
wherein the composition matter enables the quantum confinement energy conversion branch of muon surrogate catalyzed transmutation and also permits a feedback loop controlling the energy, crystal momentum and reactant injection parameters that control and quantify the reaction progress.

2. A composition of matter as in claim 1, where the reactant in a reaction region is a radioactive fission product or a neutron rich isotope or a neutron rich radioactive element

3. A composition of matter as in claim 1, where the concentration of reactant in the reaction region is bounded in the range approximately between 1% and 90%.

4. A composition of matter as in claim 1, where the concentration of transmutations in the reaction region is bounded in the range approximately between 1% and 90%.

5. A composition of matter as in claim 1, where the density of tri particles in a crystal unit cell of a material in the reaction region is greater than 2 tri particles per unit cell.

6. A composition of matter as in claim 1, where the concentration of the elements nickel and lithium do not exceed 1% of the material in the reaction region.

7. An apparatus to inject crystal momentum into a reaction region to create surrogates for a muon surrogate fusion binding reaction, and reactants for the surrogate reaction, the apparatus including:
one or more thin film less than 40 nanometers thickness, each consisting of its own combination of one or more materials that conducts both protons and electrons;
reactants in or on the thin film;
two or more thin films physically stacked upon each other forming a stack;
the stack physically pressed against a first proton conductor below the stack and pressed by a second proton conductor above the stack;
wherein when a voltage is applied across the two proton conductors and when hydrogen gas consisting of one or more of its isotopes hydrogen, deuterium and tritium is in contact with the proton conductors, the voltage forces a flow of protons from one thin film surface into another, the protons encountering an abrupt junction inject a crystal momentum with value targeted and tailored by the dimension of the abrupt junction, creating a muon surrogate stimulating a muon surrogate binding reaction.

8. An apparatus as in claim 7, wherein the reactants in or on the thin film are radioactive fission products and the form of hydrogen passing through the thin films is a proton.

9. An apparatus as in claim 8, wherein the radioactive fission product includes one or more from the group 137-caseium, 90-Strontium.

10. An apparatus as in claim 7, wherein one or more of the thin films includes at least one proton conducting electron conductor chosen from the group including at least palladium, titanium, nickel, vanadium, zirconium, niobium and tantalum.
